(19) United States
(12) Patent Application Publication
(10) Pub. No.: US 2008/0173595 A1
(43) Pub. Date: Jul. 24, 2008

(54) Automated Concentration System

(75) Inventors: Daniel V. Lim, Tampa, FL (US); Elizabeth A. Kearns, Tampa, FL (US); Richard Darrell Sorrells, Safety Harbor, FL (US); Timothy Arthur Postlewaite, Oldsmar, FL (US)

Correspondence Address: SMITH HOPEN, PA, 180 PINE AVENUE NORTH, OLDSMAR, FL, 34677, US

(73) Assignees: UNIVERSITY OF SOUTH FLORIDA, Tampa, FL (US); CONSTELLATION TECHNOLOGY CORPORATION, Tampa, FL (US)

(21) Appl. No.: 11/841,215

(22) Filed: Aug. 20, 2007

Related U.S. Application Data
(63) Continuation of application No. PCT/US06/06002, filed on Feb. 21, 2006.
(60) Provisional application No. 60/593,848, filed on Feb. 18, 2005.

(51) Int. Cl. B01D 37/00; B01D 35/26; B01D 35/02

(52) U.S. Cl. 210/806; 210/92; 210/108

(57) ABSTRACT

An in-line water monitoring system for the detection of the accidental or intentional introduction of potentially harmful substances. The automated system comprises a water pressure driven concentration unit that filters drinking water through a hollow-fiber filter. Material collected on the filter is backflushed into a collection vessel by passing a sterile solution through the filter in the reverse direction. An electronic signal at the end of the backflush sequence triggers a sensor such as an array biosensor to begin processing and analyzing the sample. The array biosensor houses a slide prepared with antibodies to the test organism. The array biosensor is programmed to automatically run sample and detection reagents over the slide, analyze the resulting pattern for positive and negative data, and report the results.

### CROSS REFERENCE TO RELATED APPLICATIONS

This application is a continuation of International patent Application PCT/US2006/006002 filed Feb. 18, 2006 which claims priority to U.S. Provisional Patent Application 60/593,484, filed Feb. 18, 2005; which is fully incorporated herein by reference.

### GOVERNMENT SUPPORT

This invention was developed under support from: the U.S. Army Research, Development and Engineering Command (RDECOM) under grant DAAD13-00-C-0037, accordingly the U.S. government may have certain rights in the invention; and Pinellas County Utilities under grant 1209-101-700, who may have certain rights in the invention.

### BACKGROUND OF THE INVENTION

The safety of drinking water has long been a concern of water utilities and other government entities. Current analysis methods take several days to accomplish and there is a desire for more rapid methods of determining when a potential health hazard is present in a water supply. In addition, potable water supplies are considered part of the U.S critical infrastructure that has been mandated to increase security since Sep. 11, 2001. Military services are also concerned about the security of this critical resource at military bases and temporary field military installations.

The prior art describes methods using hollow-fiber filter ultra-filtration to concentrate microorganisms from water for subsequent detection. Previous methods, however, require manual control of the system; none are amenable to being automated. Previous attempts to detect the presence of microorganisms require the sample to be transported to a remote location to be tested. Existing systems also require pretreatment of the filter prior to concentration in order to achieve adequate concentration of the targeted microorganisms. Pre-treatment increases the complexity of the concentration process and prevents automation of the system.

Therefore, what is needed is an automated device that is capable of being placed online in a flow system to monitor for the presence of microorganisms.

### SUMMARY OF INVENTION

This invention provides a method of concentrating hazardous biological material, including bacteria, viruses and toxins, from water sources. The concentrator may be coupled to a sensor that screens the concentrate for the presence of designated hazardous substances. Users can continuously concentrate potentially hazardous materials from a water source for a desired amount of time by placing it in the water flow path or by diverting a subset of the water flow to the concentrator. For example, the device could be placed in the public drinking water distribution system and used to monitor the security of this critical resource. While the protection of potable water resources provides the broadest benefit, other types of water or liquid streams can also be monitored using this technology and multiple uses are contemplated.

The inventive system includes an on-line water concentration system to facilitate the detection of potentially harmful substances. The automated system comprises a water pressure driven concentration unit that filters drinking water through a hollow-fiber filter. Material collected on the filter is backflushed into a collection vessel by passing a sterile solution through the filter in the reverse direction. An electronic signal can be delivered at the end of the backflush sequence to trigger a sensor, such as an array biosensor, to begin processing and analyzing the sample. The array biosensor houses a slide prepared with antibodies to the test organism. The array biosensor is programmed to automatically run sample and detection reagents over the slide, analyze the resulting pattern for positive and negative data, and report the results.

The inventive system removes any hazardous material suspended in the fluid that is greater than the pore size of the filter to create a concentrate. The use of subsystems makes filter pretreatment unnecessary. Analysis of the concentrate thereby alerts a user to any hazardous material discovered and identified. The process is automated and requires an attendant where a harmful material is discovered or if maintenance is required.

### BRIEF DESCRIPTION OF THE DRAWINGS

For a fuller understanding of the nature and objects of the invention, reference should be made to the following detailed description, taken in connection with the accompanying drawings, in which:

FIG. 1 is a schematic representation of the invention showing the integrated system.

FIG. 2 is a schematic representation of the invention showing the flow path of the forward flow concentration subsystem.

FIG. 3A is a schematic representation of the invention showing the flow path of the air flush subsystem.

FIG. 3B is a schematic representation of the invention showing the flow path of the liquid backflush subsystem.

FIG. 4 is a schematic representation of the invention showing the flow path of the cleaning subsystem.

FIG. 5 is a schematic representation of the invention showing the flow path of the purge subsystem.

FIG. 6A is a table of data from experiments using the inventive method.

FIG. 6B is a table of data from experiments using the inventive method.

FIG. 6C is a table of data from experiments using the inventive method.

FIG. 7 is a table of data from experiments using the inventive method.

### DETAILED DESCRIPTION OF THE PREFERRED EMBODIMENT

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The concentration system filters particulate matter that is larger than the pore size of the filter from a liquid stream. Particulate matter collects within the hollow cores of the filter fibers. The collected particulate material is recovered by back-flushing the filter with a predetermined volume of liquid such as water, buffer or other solution. The concentration of collected particulate matter (e.g., bacteria, viruses, toxins) is much greater in the recovered concentrate than in the original water source. The concentrate may be directed to a sensor for detection and identification of its constituents. The inventive system also includes a cleaning function that washes the filter after every concentration cycle and readies the filter to start a new cycle. The entire process is automated and controlled by a programmable logic controller. The programmable logic controller can be equipped with software tailored to the system's intended use. Examples of programmable variables include, inter alia, collection time, purge delay and time, volume of backflush solution, cleaning time and delivery of the concentrate sample to a biosensor for detection.

One embodiment of the inventive system employs a filter capable of processing large volumes of water. By way of example only, one embodiment uses a unique filter produced by Norit Membrane Technology Bv (Netherlands) that is amenable to processing large volumes of water. The ideal filter has backflush capabilities. Backflushing of the filter removes particulate matter collected on the interior of the filter fibers. Backflushing also accommodates periodic cleaning of the filter, thereby extending filter-life. The process of filtering and removal of particulates from an ultrafilter via backflushing is referred to as dead end ultrafiltration.

The following represents an illustrative device developed based on the methods of the inventive system. This example represents only one filtration device that permits concentration of particles, including microorganisms, from the liquid flow according to the inventive method.

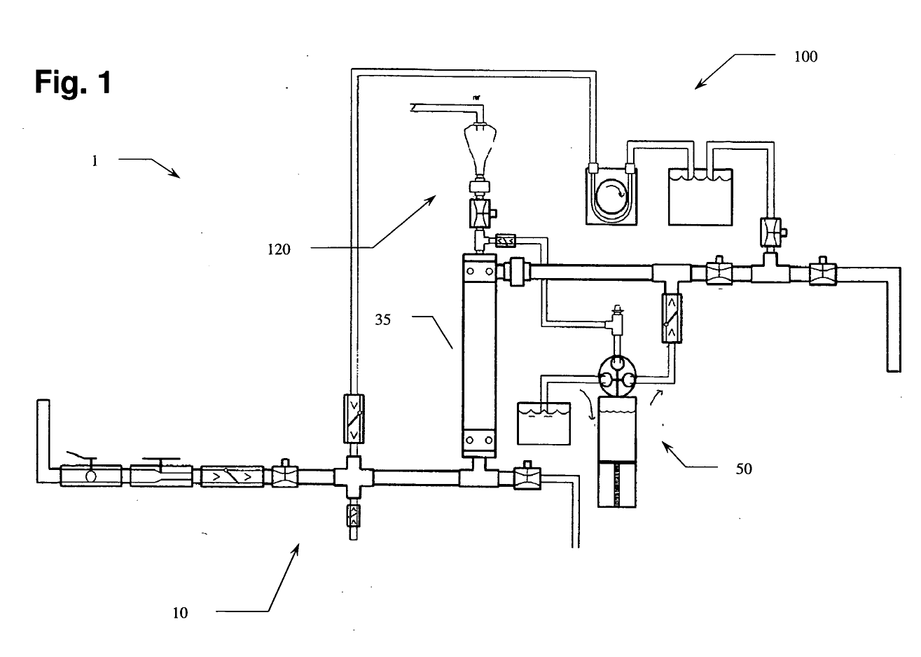

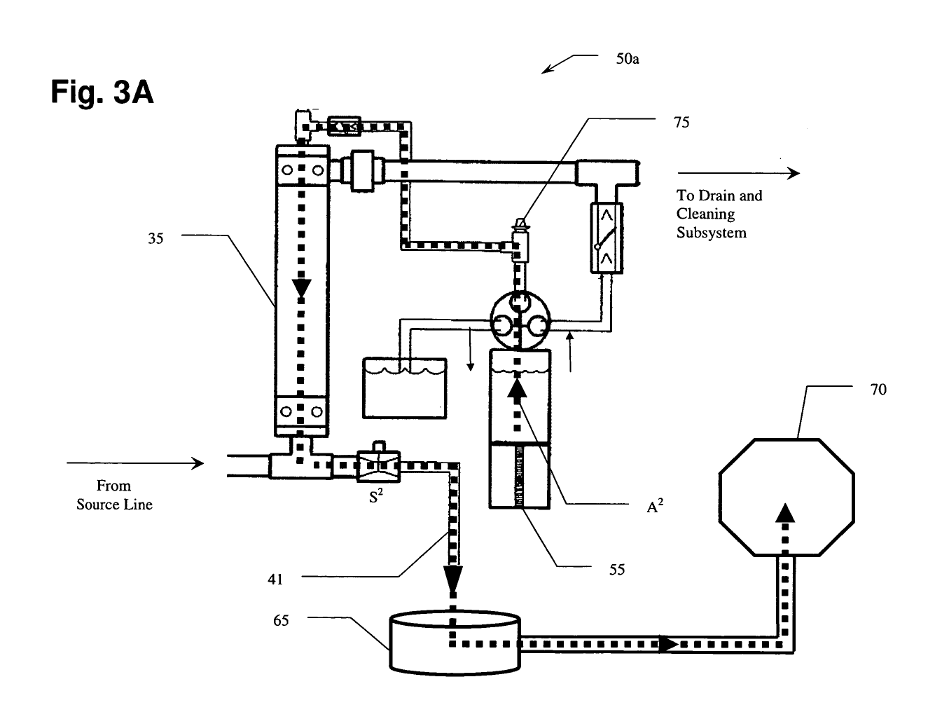

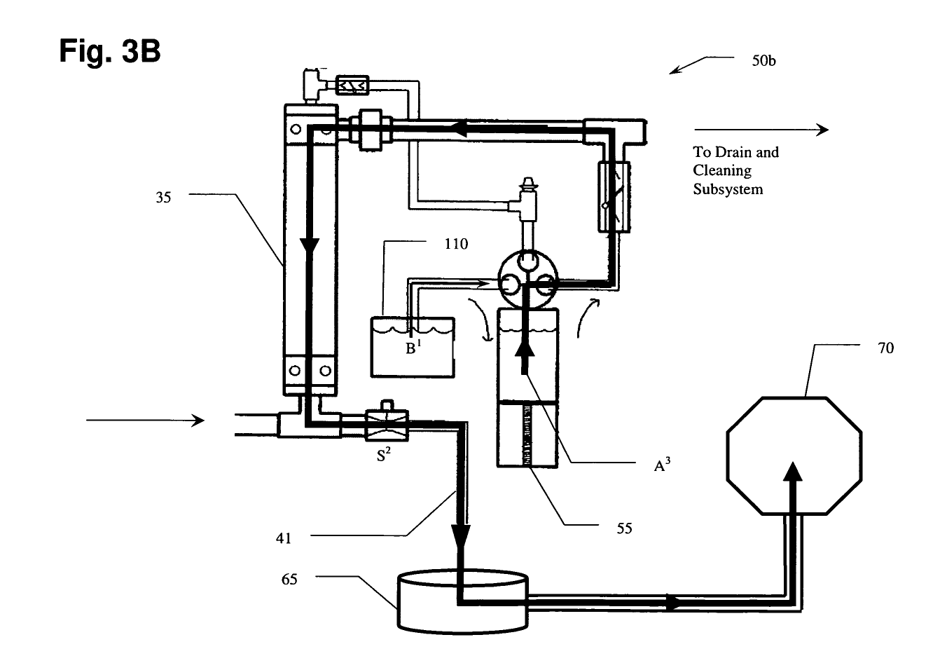

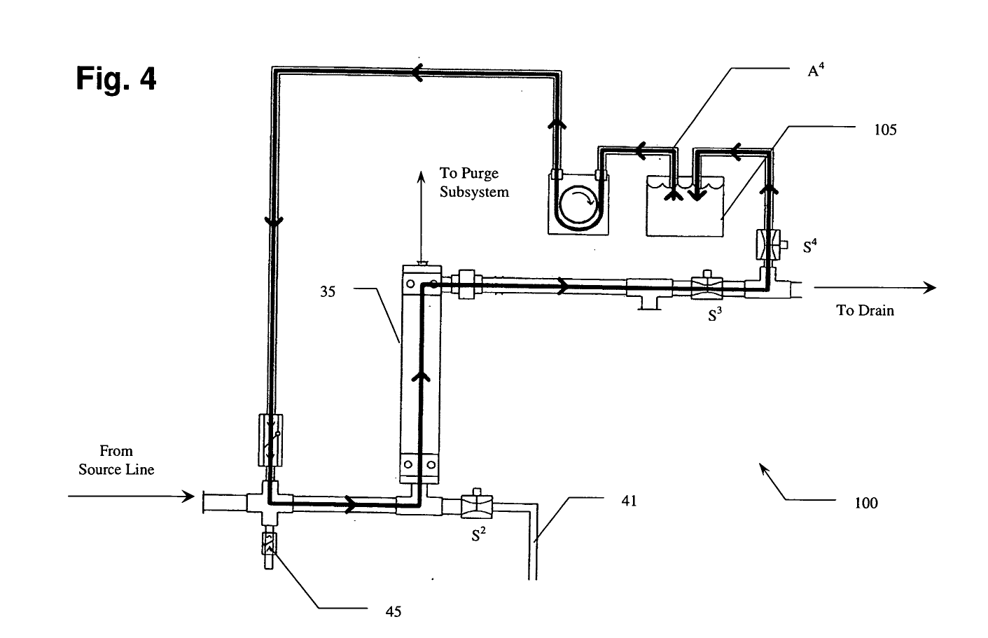

Referring now to the figures, FIG. 1 shows a schematic view of an illustrative device. Discussion of this particular embodiment will lend a greater understanding of the inventive method, although other embodiments are contemplated. Automated Concentration System (ACS) 1 is best understood when viewed in light of its modular elements. ACS 1 comprises forward-flow concentration subsystem 10, backflush subsystem 50, cleaning subsystem 100 and purge subsystem 120. Backflush subsystem 50 further comprises liquid-backflush subsystem 50a (FIG. 3B) and air-backflush subsystem 50b (FIG. 3A).

Programmable Logic Controller (PLC)

Automation of the inventive system is possible with the use of a programmable logic controller (PLC). The term programmable logic controller (or PLC) as used herein is any device used for the automation of the disclosed system. While the PLC usually will incorporate a microprocessor, device relying on mechanical control (i.e. timers) are also contemplated. In a preferred embodiment the PLC remains in electronic communication with the consituent elements of the system, including sensors, valves, solenoids, pumps, gauges and actuators. The input/output arrangements necessary to practice the invention may be built into a simple PLC, or the PLC may have external input/output modules attached to a proprietary computer network that plugs into the PLC. Although the current system is optimized for automation, manual operation is also envisioned.

In a preferred embodiment the PLC is equipped with software that provides an interface for control of forward flow (concentration) time, purge delay and length, interior filter drain time, number of air flushes, number of backflush sequences, cleaning solution circulation time and cleaning solution flush sequence and time. A system diagram incorporated into the user interface can provide feedback on flow paths during operation. Controls may also be provided to configure the system for introduction of a sample to test the operation of the system. An assay recipe program directs the sequence of concentration steps. The recipe program includes a choice of standard concentration processes or provides flexibility by allowing the user to encode a different sequence, if desired, prior to initiating the concentration process.

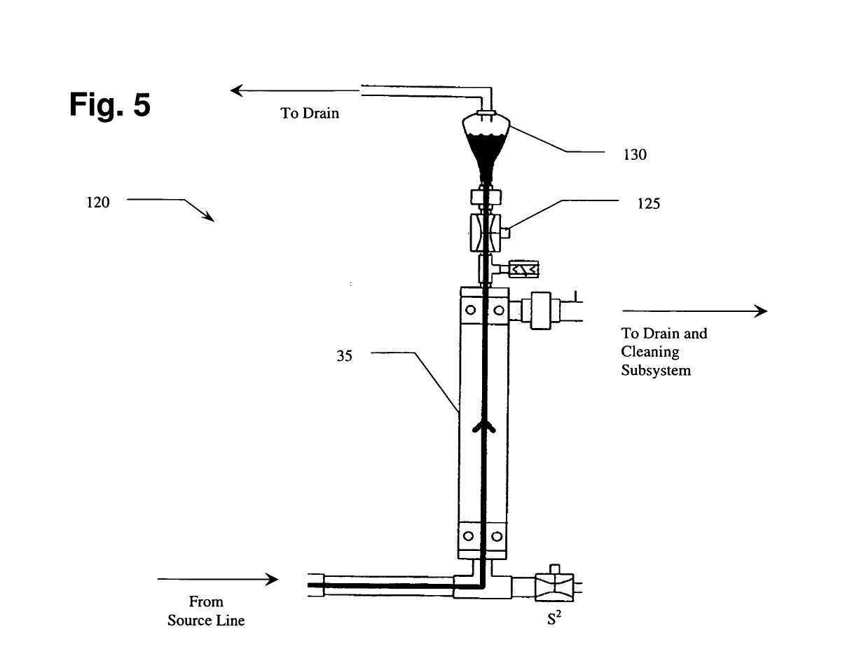

The PLC controls flow through the system by opening and closing solenoid valves, S¹ through S⁵, located at strategic points on the system. In the cleaning sequence shown in FIG. 5, for example, the PLC would open solenoid valves S³ and S⁴ but close solenoid valves S1, S² and S⁵ (see FIG. 1). A check valve can be incorporated to prevent the introduction of fluid into the backflush subsystem.

Forward-Flow Concentration Subsystem (FFC)

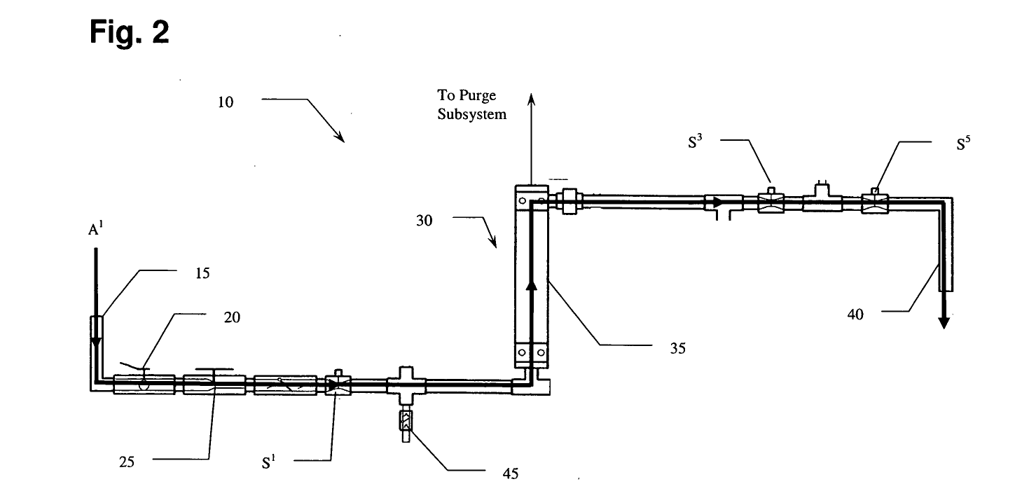

Forward-flow concentration subsystem (FFC) 10, shown in FIG. 2, includes filter housing 35, containing hollow fiber filter 30, with a support structure that permits water to be pushed through the filter using only the pressure from source line 15. The direction of water flow through FFC 10 is indicated by arrow A¹. In one embodiment flow to filter 30 is controlled by ball valve 20, to turn flow on and off, and needle valve 25 to adjust the pressure of the water into filter 30. An optional pre-filter, not shown, may be installed to remove large particulates that could clog filter 30 in applications involving relatively dirty water. For example, a pre-filter may be installed between ball valve 20 and needle valve 25.

Water is directed into the interior of the hollow fibers of filter 30 wherein particles larger than the pore size of the filter are retained within the fiber cores and all other material passes to the exterior space of filter cartridge 35. Accordingly, the pore size of the filter can be selected to target a specific type of pathogen or particulate matter. In the embodiment shown in FIG. 2, water continues to flow to drain 40. In alternate embodiments, water and material not trapped by filter 30 is discarded or is transferred back to the source flow line or an alternate location. Optional spiking port 45 allows a user to introduce a sample; e.g. to test system operation.

Backflush Subsystem

The programmable logic controller (PLC) initiates backflush subsystem 50 after a predetermined amount of water passes through filter 30. The PLC turns off water flow to filter 30 prior to engaging a backflush sequence. Backflush subsystem 50 permits either a gravity drain of the fiber cores, an air-flush of the fiber cores (FIG. 3A) or a liquid backflush of a solution of choice (FIG. 3B) through the fiber to remove particulate material trapped within filter 30. In this embodiment, both air-backflush subsystem 50a and liquid-backflush subsystem 50b use a 50-ml syringe pump. While other mechanisms can be used, the use of a syringe pump for backflush sequences provides better control over the backflush sequence and concentrate collection process. The gravity drain function is accomplished by opening solenoid valves located on the top and bottom of the filter blocks that hold filter cartridge 35 in position. The sequence of the three backflush options are programmed into, and controlled by, the PLC. Particulate matter released from filter 30 passes through sample-drain 41 and is collected in collection vessel 65. Material in collection vessel 65 is delivered to biosensor 70 for detection and identification of particulates. A pressure gauge is located in a position that permits measurement of the backflush pressure.

Air-backflush subsystem 50a is outlined in FIG. 3A. Although this embodiment uses ambient air to flush the system, any fluid can be incorporated and the selection of an appropriate gas will require an analysis of the intended use of the system. Here, the PLC initiates an air-backflush sequence thereby starting pump 55, which then draws air through air-valve 75. The air then travels under pressure along path of travel A² through filter 30, thereby removing liquid from the fiber cores along with some particulate matter trapped therein. The sample continues along path of travel A² through sample-drain 41 into collection vessel 65. The sample can be directed from vessel 65 to the optional biosensor 70 responsive to a signal from the PLC. Parameters governing delivery to the biosensor are varied but can include time and or volume. Useful biosensors are known and will be apparent to one skilled in the art considering factors such as the particulate matter being analyzed and the intended use of the system. Examples of useful biosensors include the RAPTOR (Research International, Inc.) and the ACA-ABS (Constellation Technology Corporation).

Liquid flow through liquid-backflush subsystem 50b, detailed in FIG. 3B, is shown by directional arrows B¹ and A³. Solution reservoir 60 is placed in fluid communication with syringe pump 55. Solution reservoir 60 can be filled with any liquid, the selection of which may vary depending on the system's intended use. Commonly, reservoir 60 will be filled with a predetermined quantity of water, buffer or other solution. Reservoir 60 can also be placed in fluid communication with a source of the selected liquid thereby enhancing the system's automation. The liquid-backflush sequence is initiated by the PLC which starts pump 55. Solution is drawn from reservoir 60 along path of travel B¹ to pump 55. From pump 55 the solution continues along path of travel A³ through filter 30 from the cartridge space to the inside of the fiber cores, thereby removing any concentrated particulate matter trapped therein to form a sample. The sample continues along path of travel A³ through sample-drain 41 into collection vessel 65. The sample can be directed from vesicle 65 to biosensor 70 responsive to a signal from the PLC. Parameters governing delivery to the biosensor are varied but can include time and or volume.

The inventive method is not limited by any one sequence of events. The clearing of the fiber cores in filter 30 with air before backflushing the filter with liquid, however, enhances the efficiency of the backflush step.

Cleaning Subsystem

The cleaning sequence initiates responsive to a signal from the PLC once the particulate matter in filter 30 has been backflushed into the collection vesicle. Cleaning solution reservoir 105 incorporates a precision temperature control device. In this illustrative embodiment reservoir 105 holds up to 5 liters of cleaning solution at a user-determined temperature. Cleaning subsystem 100 sequence circulates the heated cleaning solution through filter 30 in the forward flow path of travel (A⁴). A cleaning cycle is completed when the cleaning solution returns to reservoir 105, but multiple cleaning cycles can be incorporated into a single cleaning sequence. The type of solution, cleaning temperature and length of cleaning cycle are determined by the user. The cleaning solution is removed from filter 30 and system lines by a combination of forward flow and backflush events initiated by the PLC.

A new forward flow concentration cycle is started upon the successful completion of the cleaning sequence. If desired, two or more units can be linked to the source flow and collection alternated between the two units. Redundant use of the inventive system ensures that one unit is operational while the other is being cleaned thereby eliminating gaps in collection.

Purge Subsystem

Purge subsystem 120, FIG. 5, comprises purge valve 125 and purge reservoir 130. Purge valve 125 and purge reservoir 130 are optimally positioned at the top of filter cartridge 35 to permit the escape of any air or gas that has collected within filter cartridge 35. This safety features prevents flow shutdown due to air pressure buildup at the outflow point of filter cartridge 35. Pressure gauges located on the inlets and outlets of filter cartridge 35 permit the pressure across the membrane to be monitored.

### Example I

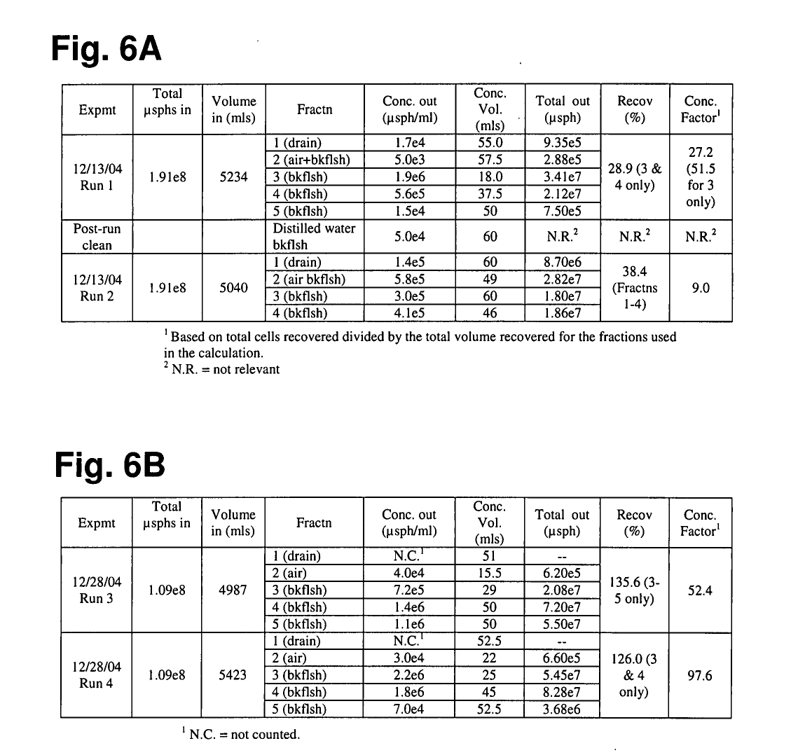

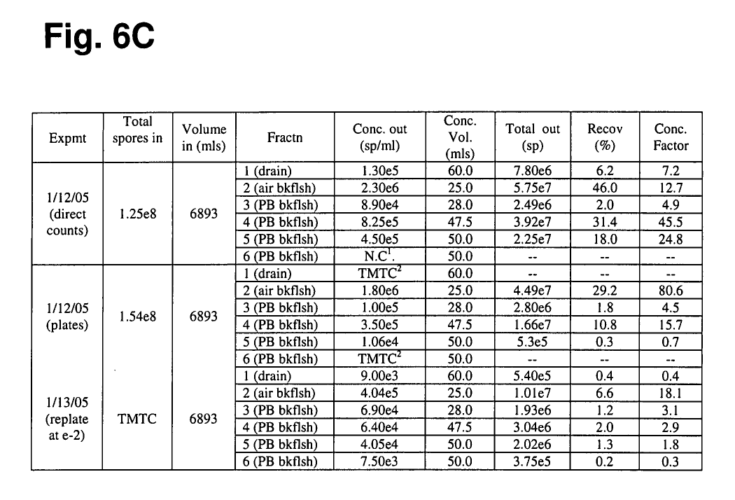

The following makes reference to the test data provided in FIGS. 6A through 6C.

Runs 1 & 2 (FIG. 6A).

A new 0.8 mm Norit filter or a used filter that had been soaking in 1% bisulfite solution preservative was used for the each test. The filter was installed and washed with water from the faucet, which was fed by drinking water. The filter was then backflushed with distilled water. The pH of permeate and recovered backflush liquid was measured during cleaning to ensure that the bisulfite was removed from the filter prior to beginning a concentration run. Prior to spiking with microspheres, water was run through the filter in the forward direction for 5-7 minutes and the transmembrane pressure and flow rate were measured.

For the tests, 700 μl of a 2.733×10⁸ spheres/ml (in phosphate buffer, pH 7.4) concentration of fluorescent microspheres (1 μm, carboxylate-modified, yellow-green FluoSpheres, Molecular Probes, Eugene, Oreg.) were diluted into 10 mls distilled water and injected into the concentrator using the sample injection port and with the system in “spike” mode. The microspheres were followed by 10 additional mls of water to wash them completely into the system. Forward flow was initiated and timed for 5 minutes of flow. The transmembrane pressure and flow rate were monitored during the concentration. Total recovery was better in the liquid/liquid (Run2) backflush experiment, but the concentration of the recovered material was higher in the liquid/air experiment in fractions collected after the air push.

The filter was back flushed using the following procedure:

Run 1—purge drain (to dump purge volume back into column), syringe air push through fiber centers ×1, syringe phosphate buffer backflush ×4 (water/air); and

Run 2—purge drain, syringe air push backflush (outside to inside of fibers)×1, syringe phosphate buffer backflush ×2 (water/water).

Runs 3 & 4 (FIG. 6B)

The procedure was similar to the previous tests, discussed above, except 400 μl of microspheres were spiked into the concentrator and permeate was used to dilute them instead of distilled water. The previously used filter that had been stored in bisulfite was used for the first test. The second test used a new filter. Both filters were rinsed with forward flow and backflush to rinse out bisulfite (and glycerin in the new filter). For both runs, the following fractions were collected: purge drain, syringe air push through fiber centers ×1, phosphate buffer backflush ×3.

These tests support results from the previous test showing good concentration (10⁶ spheres/ml) when the fiber centers were cleared with air prior to backflushing with phosphate buffer. The greater than 100% recovery calculated for the runs may be attributed to either microsphere accumulation on the filter or miscalculation of the spike concentration.

Run 5 (FIG. 6C)

The filter from the last microsphere run (new filter), which had been stored in bisulfite, was used. This filter was used for one microsphere run but had never been used with spores and never been cleaned using the hot NaOH procedure. A stock suspension of B. globigii spores with an average of 1.25×10⁸ spores/ml (n=2) was prepared. The stock suspension was more difficult to count this time because of the presence of unidentified junk in the suspension. One milliliter of this suspension was used to spike the filter using the same procedure described above for the microspheres. Concentrations of collected fractions were determined using both direct counts and enumeration plating. Plates done the day of the experiment were difficult to interpret so additional plates, all at the same dilution of 10⁻², were prepared in an attempt to get a better feel for the relative concentration of each fraction.

The counts for this concentration presented difficulties because there was little consistency among the three attempts at enumeration. Direct counts were difficult to obtain due to the presence of a large amount of particulates, making the counts unreliable. Note that the direct count of spores is less than counts based on plates and that the total recovery for the fractions is greater than 100%. These indicated that the direct count may not be accurate. The stock used for this experiment was stored in a desiccator cabinet at room temperature and those used previously were stored in a refrigerator.

### Example II

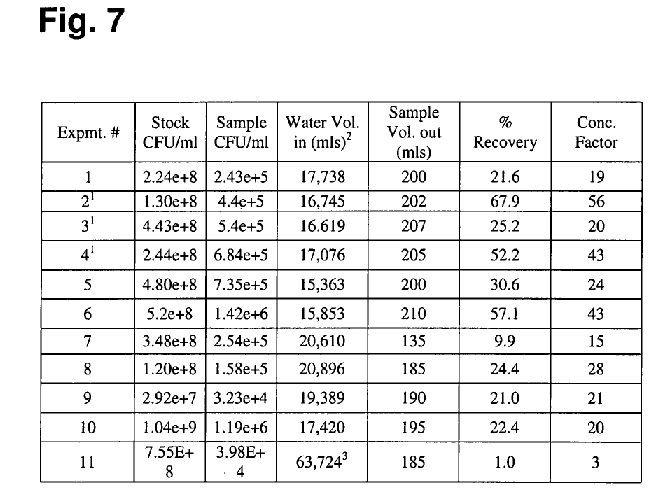

FIG. 7 shows the results of several tests of the inventive system after it was fully automated and connected to a WAMO ABS and/or WAMO TDU. All runs were done using the same protocol for recovering sample (concentrate) from the filter. The backflush solution was sterile deionized water. Spore concentrations were based on viable counts on TSA and are expressed as CFU/mL. Although this method is known to underestimate spore concentration because not all the spores will germinate, it was better than direct microscopic counts because particulates in the concentrate made it impossible to accurately identify and count spores. Improved methods of calculating spore concentrations are being investigated. Experiment #11 is a continuous concentration experiment in which the concentrator was programmed to run in a repetitive mode, consisting of 6-hour concentration intervals followed by sample recovery, for approximately 3½ days. Near the end of a 6 hour concentration period, the system was spiked with B. globigii upstream from a water softener prefilter and forward flow resumed for an additional 2 hours. All other tests were done using 15 minute forward flow times after spiking using port 45.

Referring to FIG. 7, concentrate was collected in fractions in experiments 2 through 4. The concentration of each fraction was multiplied by the volume of the fraction to get total CFU in the fraction; the total CFUs for each were summed and divided by the total volume of all fractions to calculate a concentration for the collected material. Water volume was calculated by averaging flow rates over the time of the concentration run and multiplying by the total run time. Water volume for experiment 11 only includes the water that flowed through the filter after the system was spiked with B. globigii. The ACS performed relatively consistently considering that B. globigii is known to give somewhat inconsistent recovery from filters. Recoveries calculated ranged from about 1-68%, with most (5/11) in the 20-30% range. Concentration factors ranged from 3-56 fold. Concentrations in the recovered material ranged from approximately 3×10⁴ to 1×10⁶ CFU/mL and were all detectable on the biosensor, although the positives from Experiment 9 were only faintly fluorescent. The variability could also be due to the inconsistency of viable counts. Not all B. globigii spores will germinate and the percent that do can vary greatly. Normally, viable counts are 0.5 to 1 log less than direct counts.

It will be seen that the objects set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall there between. Now that the invention has been described,

What is claimed is:

1. A method of extracting an analyte from a test-fluid, comprising the steps of:
providing a test-fluid source;
forming a concentrate by passing the test-fluid along a first path of travel through a filter whereby the analyte is captured in the filter; and
initiating a plurality of backflush sequences to remove the concentrate containing the analyte from the filter, whereby a sample is provided.

2. The method of claim 1 wherein the backflushing step further comprises the step of pumping a gas through the filter whereby fluid is removed from the fiber cores.

3. The method of claim 2 wherein the gas is ambient air.

4. The method of claim 1 wherein the backflushing step further comprises the step of pumping a liquid through the filter in an opposite path of travel than the fluid.

5. The method of claim 4 wherein the liquid is selected from the group consisting of water, a buffer and a solution.

6. The method of claim 1, further comprising the step of pumping a cleaning solution through the filter.

7. The method of claim 6 wherein the cleaning solution passes through the filter in the same path of travel as the fluid.

8. The method of claim 1 further comprising the step of purging any gas accumulated in the filter.

9. The method of claim 1 wherein each step is controlled by a programmable logic controller.

10. The method of claim 1 wherein the filter is selected to separate at least one analyte from the test-fluid.

11. The method of claim 1, further comprising the step of delivering the sample to a sensor adapted to identify the analyte.

12. An apparatus for extracting an analyte from a test-fluid, comprising:
a concentration subsystem having a filter selected to separate at least one analyte from the test-fluid; and
at least one backflush subsystem in fluid communication with the concentration subsystem, said backflush subsystem adapted to remove at least one analyte from the filter thereby providing a sample.

13. The apparatus of claim 12, further comprising a cleaning subsystem in fluid communication with the concentration subsystem, said cleaning subsystem adapted to pass a cleaning solution through the filter.

14. The apparatus of claim 13 wherein the cleaning solution passes through the filter in a same path of travel as the test-fluid.

15. The apparatus of claim 12, further comprising a purge subsystem in fluid communication with the concentration subsystem, said purge subsystem adapted to release any gas in the filter.

16. The apparatus of claim 12, wherein the concentration subsystem further comprises:
at least one test-fluid inlet; and
at least on valve adapted to control the flow of the test-fluid through the apparatus.

17. The apparatus of claim 16, wherein the concentration subsystem further comprises a ball valve, disposed between the test-fluid inlet and the filter, to turn the flow of the test-fluid on and off.

18. The apparatus of claim 16, wherein the concentration subsystem further comprises a needle valve, disposed between the test-fluid inlet and the filter, to control the pressure of the test-fluid in the concentration subsystem.

19. The apparatus of claim 12, wherein the concentration subsystem further comprises an inlet port for introducing a test-analyte into the concentration subsystem.

20. The apparatus of claim 12, further comprises a plurality of solenoid valves adapted to control the flow of the test-fluid through the apparatus.

21. The apparatus of claim 20, further comprising a programmable logic controller in communication with the solenoid valves.

22. The apparatus of claim 12 further comprising a sensor adapted to identify the analyte within the sample.

23. An apparatus for extracting an analyte from a test-fluid, comprising:
a concentration subsystem having a filter selected to separate at least one analyte from the test-fluid; and
a plurality of backflush subsystems in fluid communication with the concentration subsystem, said backflush subsystem adapted to remove at least one analyte from the filter thereby providing a sample.

24. The apparatus of claim 23, further comprising a cleaning subsystem in fluid communication with the concentration subsystem, said cleaning subsystem adapted to pass a cleaning solution through the filter.

25. The apparatus of claim 23 wherein the cleaning solution passes through the filter in a same path of travel as the test-fluid.

26. The apparatus of claim 23, further comprising a purge subsystem in fluid communication with the concentration subsystem, said purge subsystem adapted to release any gas in the filter.

27. The apparatus of claim 23, wherein the backflush subsystem comprises a liquid backflush subsystem in fluid communication with the filter.

28. The apparatus of claim 27, wherein the liquid backflush system comprises:
a liquid reservoir; and
a pump disposed between, and in fluid communication with both, the liquid reservoir and the filter.

29. The apparatus of claim 28, wherein the pump is a syringe pump.

30. The apparatus of claim 28 further comprising a check valve disposed between the reservoir and filter whereby the flow of fluid between the liquid reservoir and the filter is uni-directional.

31. The apparatus of claim 28, wherein liquid from the liquid reservoir passes through the filter in a reverse path of travel in relation to the test-fluid.

32. The apparatus of claim 23, wherein the backflush subsystem comprises a gas backflush subsystem in fluid communication with the filter.

33. The apparatus of claim 32, wherein the liquid backflush system comprises:
a gas source; and
a pump disposed between, and in fluid communication with both, the gas source and the filter.

34. The apparatus of claim 33, wherein the pump is a syringe pump.

35. The apparatus of claim 28 further comprising a check valve disposed between the gas source and filter whereby the flow of gas between the gas source and the filter is uni-directional.

36. The apparatus of claim 28, wherein gas from the gas sources passes through the filter cores only in a reverse path of travel in relation to the test-fluid.

37. The apparatus of claim 23, further comprising a collection vessel disposed between, and in fluid communication with both, the filter and the sensor.

38. The apparatus of claim 23, further comprises a plurality of solenoid valves adapted to control the flow of the test-fluid through the apparatus.

39. The apparatus of claim 38, further comprising a programmable logic controller in communication with the solenoid valves.

40. The apparatus of claim 23, further comprising a sensor adapted to identify the analyte within the sample

41. An apparatus for extracting an analyte from a test-fluid, comprising:
a concentration subsystem having a filter selected to separate at least one analyte from the test-fluid;
a backflush subsystem in fluid communication with the concentration subsystem, said backflush subsystem adapted to remove at least one analyte from the filter thereby providing a sample; and
a cleaning subsystem in fluid communication with the concentration subsystem, said cleaning subsystem adapted to pass a cleaning solution through the filter.

42. The apparatus of claim 41, further comprising a cleaning-solution reservoir in fluid communication with the filter.

43. The apparatus of claim 41 wherein the cleaning solution passes through the filter in a same path of travel as the test-fluid.

44. The apparatus of claim 41, further comprises a plurality of solenoid valves adapted to control the flow of the test-fluid through the apparatus.

45. The apparatus of claim 44, further comprising a programmable logic controller in communication with the solenoid valves.

46. The apparatus of claim 44, further comprising a sensor adapted to identify the analyte within the sample

47. An apparatus for extracting an analyte from a test-fluid, comprising:
a concentration subsystem having a filter selected to separate at least one analyte from the test-fluid;
a liquid backflush subsystem in fluid communication with the filter, said liquid backflush subsystem adapted to pass a liquid in a reverse path of travel in relation to the test-fluid, whereby at least one analyte is removed from the filter thereby providing a sample;
a gas backflush subsystem in fluid communication with the filter, said gas backflush subsystem adapted to pass a gas through the fiber cores in a reverse path of travel in relation to the test-fluid, whereby at least one analyte is removed from the filter thereby providing a sample;
a sensor adapted to identify the analyte within the sample;
a cleaning subsystem in fluid communication with the concentration subsystem, said cleaning subsystem adapted to pass a cleaning solution through the filter in a same path of travel as the test-fluid;
a purge subsystem in fluid communication with the concentration subsystem, said purge subsystem adapted to release any gas in the filter; and
a programmable logic controller in communication with the concentration, liquid backflush, gas backflush, cleaning and purge subsystems to initiate each subsystem responsive to predetermined criteria programmed thereon.
